(19) United States
(12) Patent Application Publication
(10) Pub. No.: US 2026/0203177 A1
(43) Pub. Date: Jul. 16, 2026

(54) METHODS, SYSTEMS, AND COMPUTER READABLE MEDIA FOR TESTING ELECTRICAL AND OPTICAL INTERCONNECT DEVICES

(71) Applicant: Keysight Technologies, Inc., Santa Rosa, CA (US)

(72) Inventor: Charles William Seifert, JR., Royersford, PA (US)

(21) Appl. No.: 19/450,214

(22) Filed: Jan. 15, 2026

Related U.S. Application Data
(60) Provisional application No. 63/745,607, filed on Jan. 15, 2025.

(51) Int. Cl. G06F 11/22

(52) U.S. Cl. CPC G06F 11/221

(57) ABSTRACT

A method for testing electrical and optical interconnect devices includes reading, via a port of an interconnect device test system and from an interconnect device under test, CMIS data, automatically creating an interconnect library database record in an interconnect library database, and storing the CMIS data in the interconnect library database record. The method further includes storing tap settings in the interconnect library database record. The method further includes using the CMIS data and the tap settings to configure a test for testing the interconnect device under test. The method further includes recording results of the test and storing the results of the test in the interconnect library database record. The method further includes comparing at least the CMIS data of the interconnect device under test with CMIS data of another interconnect device stored in a user-selected interconnect library database record and reporting results of the comparing.

### PRIORITY CLAIM

This application claims the priority benefit of U.S. Provisional Patent Application Ser. No. 63/745,607 filed Jan. 15, 2025, the disclosure of which is incorporated herein by reference in its entirety.

### TECHNICAL FIELD

The subject matter described herein relates to testing optical and electrical interconnect devices. More particularly, the subject matter described herein relates to methods, systems, and computer readable media for testing electrical and optical interconnect devices and automatically populating an interconnect library database with interconnect device and test data.

### BACKGROUND

Optical and electrical interconnect device test systems test interconnect devices, such as electrical and optical transceivers, to assess the performance of the interconnect devices. Testing an optical or electrical interconnect device involves physically connecting the interconnect device to a test system, setting test parameters, transmitting signals through the interconnect device, and recording results. Examples of types of parameters that are set include tap parameters, which define bias voltages applied to the device during testing, line rates for the test, equalization settings, etc. The test results that can be recorded include bit error rates, forward error correction (FEC) performance, and other parameters.

Interconnect devices include internal registers that store data about the devices. Such data is typically in the form of the common management interface specification (CMIS). CMIS data includes the device manufacturer, serial number, and operating parameters, such as temperature limits, supply voltage ranges, and bias current. Currently, these and other settings are recorded manually by the test engineer along with the test parameters and test results. Requiring the test engineer to manually record device settings, test parameters, and test results increases the time and effort required to test electrical and optical interconnect devices. When testing interconnect devices at different times, such a manual process becomes unmanageable. For example, a test engineer may test an interconnect device at one time and later return to run additional tests on the device. The two test runs may yield different results. Unless the test engineer manually records test parameters, such as tap settings, the test engineer may not be able to account for the differences in the results.

In light of these and other difficulties there exists a need for improved methods, systems, and computer readable media for testing optical and electrical interconnect devices.

### SUMMARY

A system for testing electrical and optical interconnect devices includes a housing including at least one test port for physically connecting to an electrical or optical interconnect device under test. The system further includes at least one processor and a memory located within the housing; an interconnect library database stored in the memory. The system further includes a common management interface specification (CMIS) system module executed by the at least one processor for reading, via the test port, CMIS data from the interconnect device under test, automatically creating an interconnect library database record in the interconnect library database for the interconnect device under test, storing the CMIS data in the interconnect library database record, and storing tap settings for the interconnect device under test in the interconnect library database record. The system further includes a test manager executed by the at least one processor for accessing the interconnect library database record, using the interconnect library database record, executing a test for testing the interconnect device under test, and storing, in the interconnect library database record, results of the test. The system further includes a comparator engine for comparing at least the CMIS data of the interconnect device under test with CMIS data of another interconnect device stored in a user-selected interconnect library database record and reporting results of the comparing.

According to another aspect of the subject matter described herein, the comparator engine is configured for providing a drill down function that allows a user to drill down to view details of differences between CMIS data of the interconnect device under test and the interconnect device identified in the user-selected interconnect library database record.

According to another aspect of the subject matter described herein, the comparator engine is configured to identify pages of CMIS data that are missing from the CMIS data of the interconnect device identified in the user-selected interconnect library database record.

According to another aspect of the subject matter described herein, the comparator engine is configured to display human-readable labels for the CMIS data of the interconnect device under test and the CMIS data of the interconnect device identified in the user-selected interconnect library database record.

According to another aspect of the subject matter described herein, the comparator engine is configured for comparing the tap settings of the interconnect device under test with tap settings stored in the user-selected interconnect library database record and reporting results of the comparing.

According to another aspect of the subject matter described herein, the comparator engine is configured for comparing the results of the test of the interconnect device under test with test results stored in the user-selected interconnect library database record and reporting results of the comparing.

According to another aspect of the subject matter described herein, the system includes an artificial intelligence/machine learning (AI/ML) training data exporter module for extracting data from the interconnect library database and exporting the data as AI/ML model training data.

According to another aspect of the subject matter described herein, the CMIS system module is configured to store the tap settings for a plurality of iterations of testing of the interconnect device under test in the interconnect library database record.

According to another aspect of the subject matter described herein, the test manager is configured to record, as the results of the test, a bit error metric and a forward error correction metric of the interconnect device under test.

According to another aspect of the subject matter described herein, the interconnect device under test comprises an electrical or optical transceiver.

According to another aspect of the subject matter described herein, a method for testing electrical and optical interconnect devices includes reading, via a port of an interconnect device test system and from an interconnect device under test, common management interface specification (CMIS) data. The method further includes automatically creating an interconnect library database record in an interconnect library database stored in the interconnect device test system. The method further includes storing the CMIS data in the interconnect library database record. The method further includes storing tap settings in the interconnect library database record. The method further includes using the CMIS data and the tap settings to configure a test for testing the interconnect device under test. The method further incudes recording results of the test and storing the results of the test in the interconnect library database record. The method further includes comparing at least the CMIS data of the interconnect device under test with CMIS data of another interconnect device stored in a user-selected interconnect library database record and reporting results of the comparing.

According to another aspect of the subject matter described herein, the method includes providing a drill down function that allows a user to drill down to view details of differences between CMIS data of the interconnect device under test and the interconnect device identified in the user-selected interconnect library database record.

According to another aspect of the subject matter described herein, the method includes automatically identifying pages of CMIS data that are missing from the CMIS data of the interconnect device identified in the user-selected interconnect library database record.

According to another aspect of the subject matter described herein, the method includes displaying human-readable labels for the CMIS data of the interconnect device under test and the CMIS data of the interconnect device identified in the user-selected interconnect library database record.

According to another aspect of the subject matter described herein, the method includes comparing the tap settings and results of the test of the interconnect device under test with tap settings and test results data stored in the user-selected interconnect library database record and reporting results of the comparing.

According to another aspect of the subject matter described herein, the method includes extracting data from the interconnect library database and exporting the data as AI/ML model training data.

According to another aspect of the subject matter described herein, the method includes storing the tap settings for a plurality of iterations of testing of the interconnect device under test in the interconnect library database record.

According to another aspect of the subject matter described herein, the method includes recording, as the results of the test, a bit error metric and a forward error correction metric of the interconnect device under test.

According to another aspect of the subject matter described herein, a non-transitory computer readable medium having stored thereon computer-executable instructions that when executed by a processor of a computer control the computer to perform steps is provided. The steps include reading, via a port of an interconnect device test system and from an interconnect device under test, common management interface specification (CMIS) data. The steps further include automatically creating an interconnect library database record in an interconnect library database stored in the interconnect device test system. The steps further include storing the CMIS data in the interconnect library database record. The steps further include storing tap settings in the interconnect library database record. The steps further include using the CMIS data and the tap settings to configure a test for testing the interconnect device under test. The steps further include recording results of the test and storing the results of the test in the interconnect library database record. The steps further include comparing at least the CMIS data of the interconnect device under test with CMIS data of another interconnect device stored in a user-selected interconnect library database record and reporting results of the comparing at least the CMIS data of the interconnect device under test with CMIS data of another interconnect device stored in a user-selected interconnect library database record and reporting results of the comparing.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a front perspective view of an interconnect device test system for testing optical and electrical interconnect devices;

FIG. 2 is a perspective view of an interconnect device test system and different configurations of interconnect devices under test;

FIG. 3 illustrates another test configuration where a plurality of optical transceivers is connected in series between ports of the interconnect device test system to simultaneously test a plurality of optical transceivers;

FIG. 4 is a block diagram illustrating exemplary components of interconnect device test system;

FIG. 5 is a diagram illustrating an example of data that may be included in an interconnect library database record;

FIG. 6 illustrates additional examples of interconnect device data that may be stored in the interconnect library database;

FIG. 7 illustrates an example of port configuration data that may be stored in a record in the interconnect library database along with the interconnect device data;

FIG. 8 is a diagram illustrating exemplary interconnect test result data that may be stored in interconnect library database;

FIG. 9 is a flow chart illustrating an exemplary process for testing an interconnect device under test using an interconnect device test system with interconnect library database functionality;

FIG. 10 illustrates computer screen shots of CMIS data stored in the interconnect library database for two different optical transceivers;

FIG. 11 illustrates computer screen shot of functionality provided by interconnect test system for comparing CMIS data for different optical transceivers;

FIG. 12 is a computer screen shot illustrating a summary of results of comparing CMIS data for different optical transceivers;

FIG. 13 is a computer screen shot illustrating the result of the user selecting memory page “00h” to view the differences in CMIS programming between different optical transceivers; and

FIG. 14 is a computer screen shot illustrating a graphical indication displayed by the interconnect test system to highlight missing CMIS programming when comparing CMIS data for different optical transceivers.

### DETAILED DESCRIPTION

The subject matter described herein includes an interconnect device test system with an integrated data repository integrated referred to herein as an interconnect library or interconnect library database. The interconnect library database is populated with records that may be manually, semi-automatically or fully automatically created. One data component of these records comprises CMIS information (e.g., DUT device parameters/parameter values, etc.) that is extracted/read from a network interconnect DUT device that is physically attached/coupled to one of the test system's test ports (e.g., a test system receive (Rx) port or a test system transmit (Tx) port).

In some examples, this CMIS information is automatically obtained from the associated DUT device(s) that are coupled to its test ports. In other examples, a test system user can manually input this CMIS information. Exemplary interconnect device CMIS data that could be incorporated into an interconnect library database record will be described in detail below.

CMIS data is defined in the Common Management Interface Specification (CMIS), Revision 5.3, Implementation Agreement (IA), Optical Interconnect Forum (OIF), OIF-CMIS-052, Sept. 4, 2024, the disclosure of which is incorporated herein by reference in its entirety Interconnect devices are programmed with CMIS data, which is typically stored in internal registers of interconnect devices. Such registers are typically stored in an electrically erasable programmable read only memory (EEPROM) of an interconnect device. According to the subject matter described herein, the interconnect device test system may automatically read CMIS data from the EEPROM of an interconnect device and store this data along with data used to manage the interconnect device and test results in an interconnect library database record. In one example, an electronic copy or image of the entire set of CMIS data of an interconnect device with all the CMIS pages stored for that device may be included in the interconnect library database record.

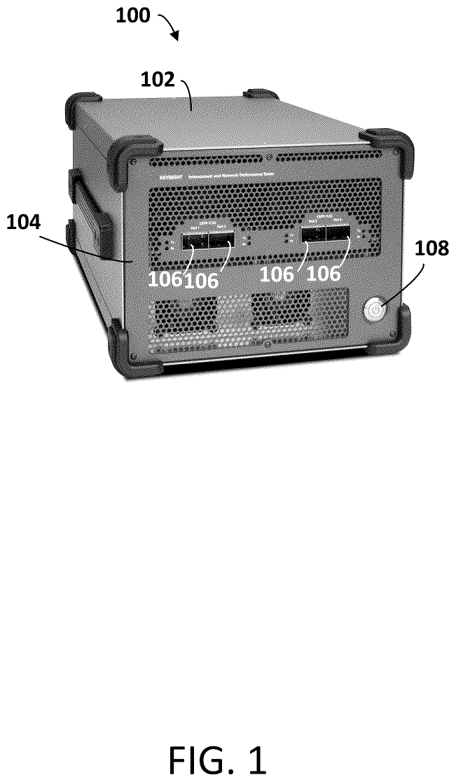

FIG. 1 is a front perspective view of an interconnect device test system for testing optical and electrical interconnect devices. Referring to FIG. 1, an interconnect device test system 100 includes a housing 102 that defines an enclosure for internal electronic components of interconnect device test system 100. Housing 102 includes a font panel 104. Front panel 104 includes a plurality of ports 106 for physically connected to interconnect devices under test. In the illustrated example, ports 106 include octal small form factor pluggable (OSFP) ports for connecting to electrical and optical transceivers, such as 400 gigabit (400 G), 800 G, 1.6 terabit (1.6 T), 3.2 T, and higher speed transceivers used in datacenters and other installments requiring high speed interconnections between networked components, such as switches and routers. Front panel 104 further incudes a power switch 108 for activating and deactivating interconnect device test system 100.

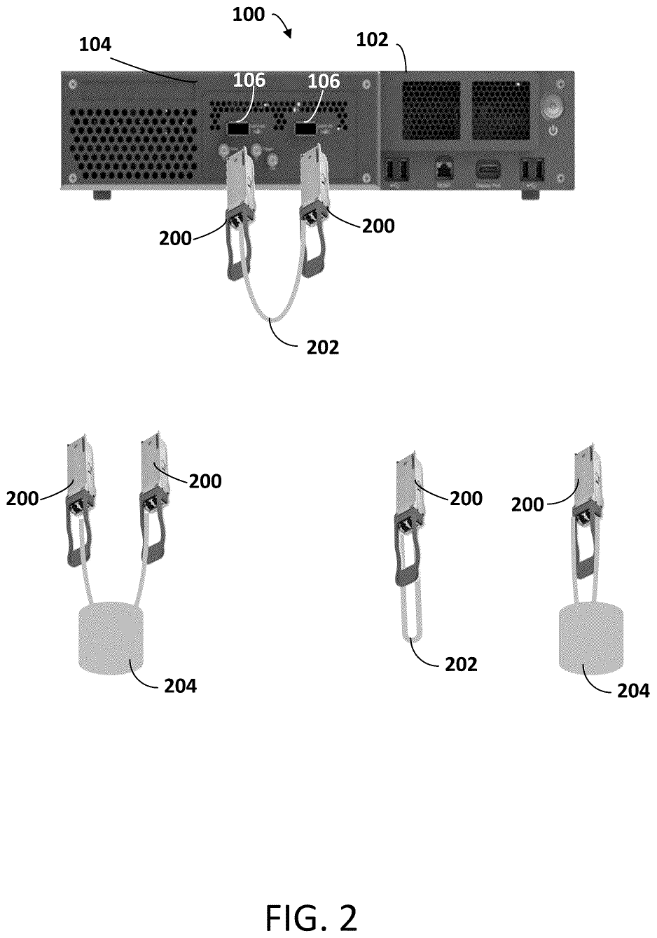

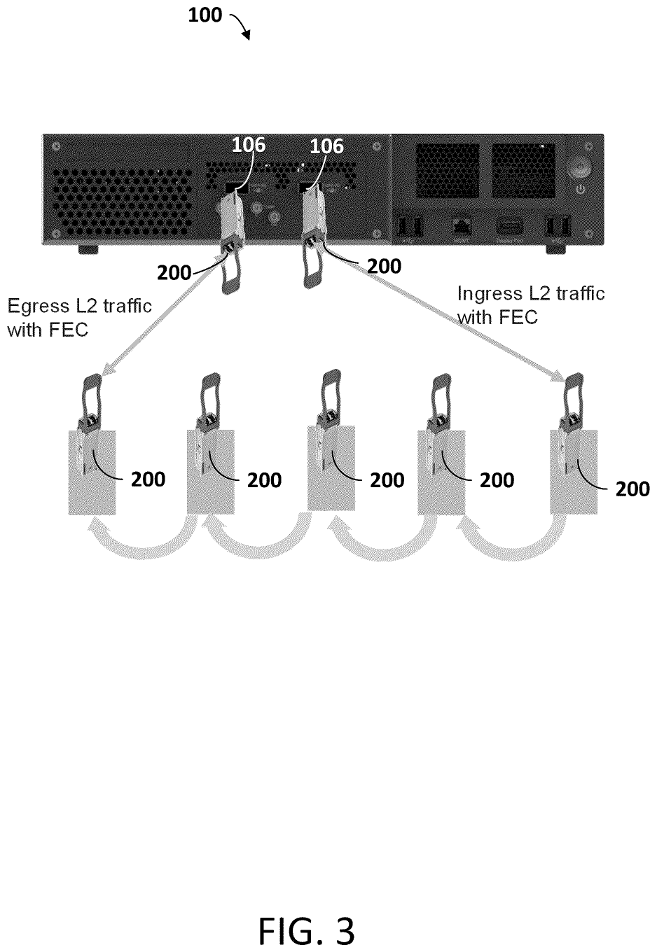

FIG. 2 is a perspective view of interconnect device test system 100 and different configurations of interconnect devices under test. In FIG. 2, interconnect devices under include optical transceivers 200. In one test configuration, two optical transceivers 200 are connected to ports 106 and are connected to each other by a short length of optical fiber 202. In another test configuration, two optical transceivers 200 can be connected to ports 106 and are connected to each other via a spool 204 of optical fiber. In another test configuration, a single optical transceiver 200 is connected to port 106 and a short length of optical fiber 202 is the optical transceiver in a loopback configuration. In another test configuration, a single optical transceiver 200 is connected to port 106 and a spool 204 of optical fiber is the optical transceiver in a loopback configuration. FIG. 3 illustrates another test configuration where a plurality of optical transceivers is connected in series between ports 106 to simultaneously test a plurality of optical transceivers 200.

In any of the test configurations illustrated in FIG. 2 or 3, interconnect device test system 100 may conduct a plurality of tests of optical transceivers 200 by transmitting signals carrying layer 2 frames and measuring errors in the layer 2 frames. Examples of error metrics that can be collected include pre-forward error correction (FEC) bit error rate (BER), pre-FEC frame loss rate (FLR), error distribution across FEC codewords, error density across electrical lanes, FEC performance (pass/fail versus tolerance, layer 2 frame statistics, and pass/fail reports versus user-defined thresholds.

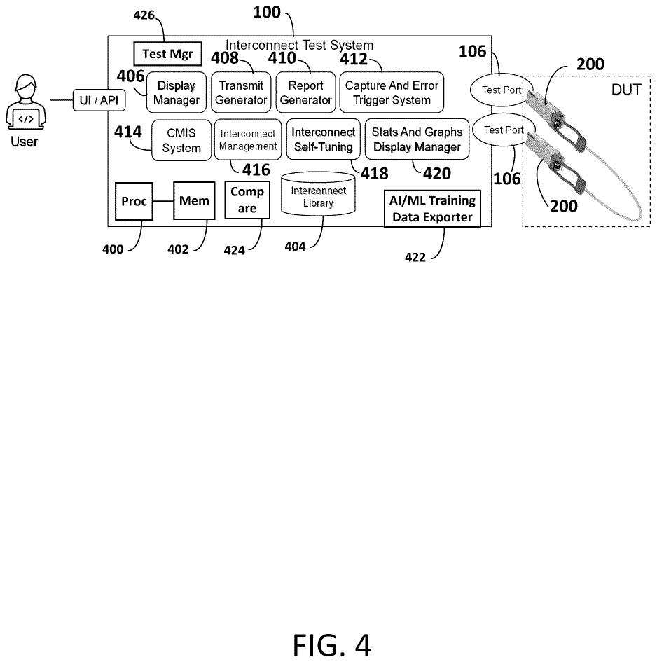

FIG. 4 is a block diagram illustrating exemplary components of interconnect device test system 100. Referring to FIG. 4, interconnect device test system 100 includes at least one processor 400 and memory 402. Interconnect device test system 100 includes an interconnect library database 404 that stores information regarding interconnect devices under test, such as CMIS information, test configuration information, and test result information. Interconnect device test system 100 further includes a display manager 406, a transmit generator 408, a report generator 410, and a capture and error trigger system module 412. Display manager 406 allows the user to define tables of data that the user wishes to see and saves the information. Display manager 406 enables the user to view transmit setup and test results. Display manager 406 also enables the user to view tap configuration, interconnect status, and alarms. Display manager 406 enables the user to display layer 2 frame statistics, such as FEC statistics, physical coding sublayer (PCS) statistics, and BER statistics. Transmit generator 408 enables the user to define test transmit parameters. Examples of such parameters include port setup, speed selection, and error injection parameters. The setup information is made available to report generator 410. Transmit generator 408 also allows the user to perform stream set up and input bit error rate test setup parameters, including layer 2 Ethernet parameters, FEC parameters, and PCS parameters. Report generator 410 allows the user to define the content of reports output by interconnect device test system 100. Examples of report content that can be configured include many of the same parameters configurable by display manager 406.

Interconnect device test system 100 further includes a capture and error trigger system module 412, a CMIS system module 414, an interconnect management system 416, an interconnect self-tuning controller 418, and a stats and graphs display manager 420. Capture and error trigger system module 412 captures test data from tests and provides the captured to display manager 406 and to the report generator 410. Capture and error trigger system module 412 enables the user to define capture filters, error thresholds, error windows per lane and per port, for bit error rate and forward error correction. CMIS system module 414 enables the user to define CMIS parameters that are displayed and at will exporting of CMIS data. CMIS system module 414 also enables the user to specify which CMIS data will be made available to and stored in interconnect library database 404. CMIS system module 414 also reads and writes the registers of an interconnect device under test. For example, CMIS system module 414 may automatically read CMIS data stored in an EEPROM of an interconnect device under test, create an interconnect library database record, and store the CMIS data read from the interconnect device under test and store the data in the interconnect library database record.

Interconnect management system 416 enables the user to define contents that will be included in an interconnect library database record. Interconnect management system 416 also enables the user to access, modify, and delete interconnect library database records. Interconnect self-tuning controller 418 manages port setup, start/stop of processes, display of test results. Interconnect self-tuning controller 418 allows the user to add/modify input into interconnect library database records. Statistics and graphs display manager 420 creates default graphs for bitt error rate statistics, forward error correction statistics, and layer 2 frame statistics.

One aspect of the interconnect device test system described herein is interconnect library database 404. Interconnect library database 404 is populated with records that may be manually, semi-automatically or fully automatically created. One data component of these records comprises CMIS information (e.g., DUT device parameters/parameter values, etc.) that is extracted/read from a network interconnect DUT device that is physically attached/coupled to one of the test system's test ports (e.g., a test system receive (Rx) port or a test system transmit (Tx) port).

In one example, this CMIS information is automatically obtained from the associated DUT device(s) that are coupled to the test ports of interconnect device test system. In other examples, a test system user can manually input this CMIS information.

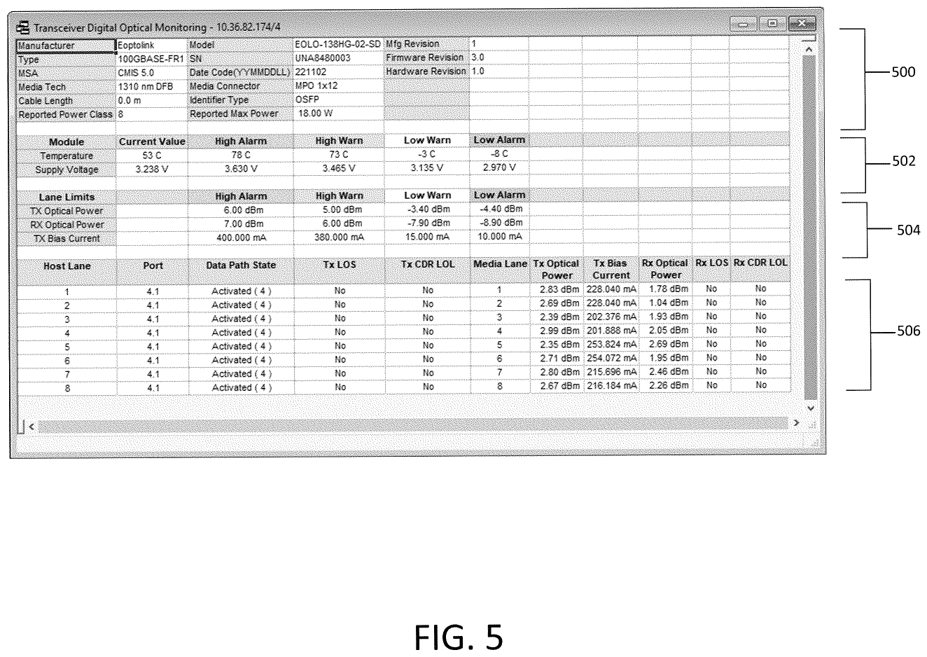

Exemplary interconnect device CMIS data that could be incorporated into an interconnect library database record is shown in FIG. 5. In FIG. 5, the CMIS data that may be automatically populated into an interconnect library database record includes interconnect device manufacturer information 500, interconnect device module information 502, interconnect device lane information 504 and host device lane information 506. Interconnect device manufacturer information 500 includes manufacturer name, device type, model information, hardware and firmware revisions, etc. Interconnect device module information 502 includes information about interconnect device temperature and supply voltage modules. Interconnect device lane information 504 includes optical power limits for interconnect device lanes. Host device lane information 506 includes information about host device lanes, such as port information, optical power information, and activation state of host device lanes. Any of the data illustrated in FIG. 5 may be automatically stored in an interconnect library database record when an interconnect device is connected to one of ports 106 of interconnect device test system 100. For example, when a device under test is connected to one of the test ports of interconnect device test system 100, interconnect device test system 100 may read the CMIS data from the EEPROM of the interconnect device under test, create a record in interconnect library database 404, and store the CMIS data in the interconnect library database record.

The interconnect devices are programmed in an organized manner with many different types of information. Interconnect device test system 100 uses the data programmed into the interconnect device by the interconnect device manufacturer to create the records in interconnect library database 404. Interconnect device test system 100 combines and stores in interconnect library database 404 the CMIS, data generated by the test engineer regarding the interconnect device under test, and the port electronics that control the device. In one example, interconnect device test system 100 may automatically read and store, in a record in interconnect library database, an image of the entire set of CMIS data present in the EEPROM of an interconnect device under test.

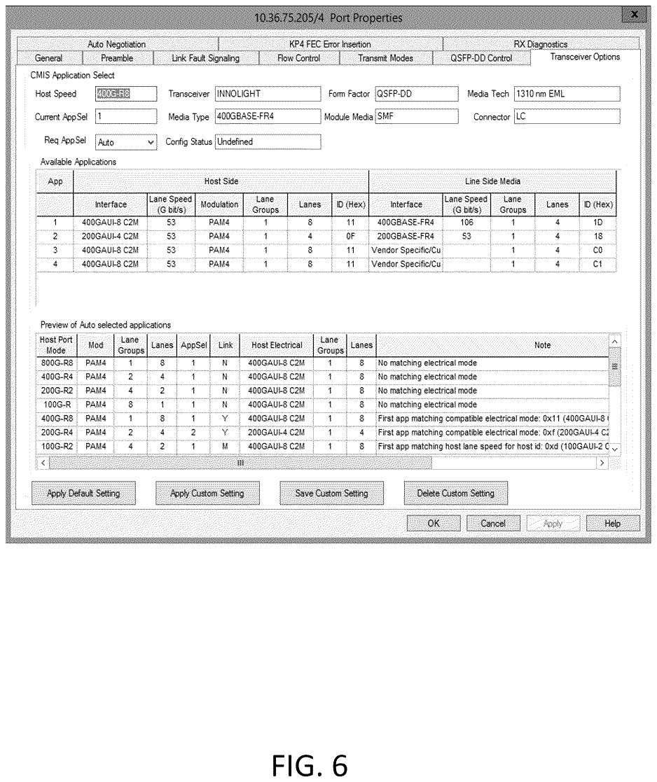

FIG. 6 illustrates additional examples of data that may be stored in interconnect library database 404. The data illustrated in FIG. 6 includes additional test port property/setting/configuration data that is used to configure the interconnect device under test that is plugged into a port 106 of interconnect test device 100. In FIG. 6, the configuration includes different Ethernet data rates that may be used during a test of an interconnect device under test.

The following are examples of CMIS data that may be stored in interconnect library database 404:
1. Module Identification Data:
   Vendor name
   Part number
   Serial number
   Manufacturing date
2. Operational Status Data:
   Temperature
   Voltage levels
   Laser bias current
   Optical power levels (transmit and receive)
3. Configuration Settings Data:
   Data rate settings
   Power mode settings
   Application-specific configurations
4. Diagnostics and Monitoring Data:
   Error counts (e.g., bit error rate)
   Alarm and warning thresholds
   Historical performance data
5. Firmware Information Data:
   Firmware version
   Supported features and capabilities
6. Interoperability Data:
   Compatibility information with different network
   equipment
   Supported protocols and standards

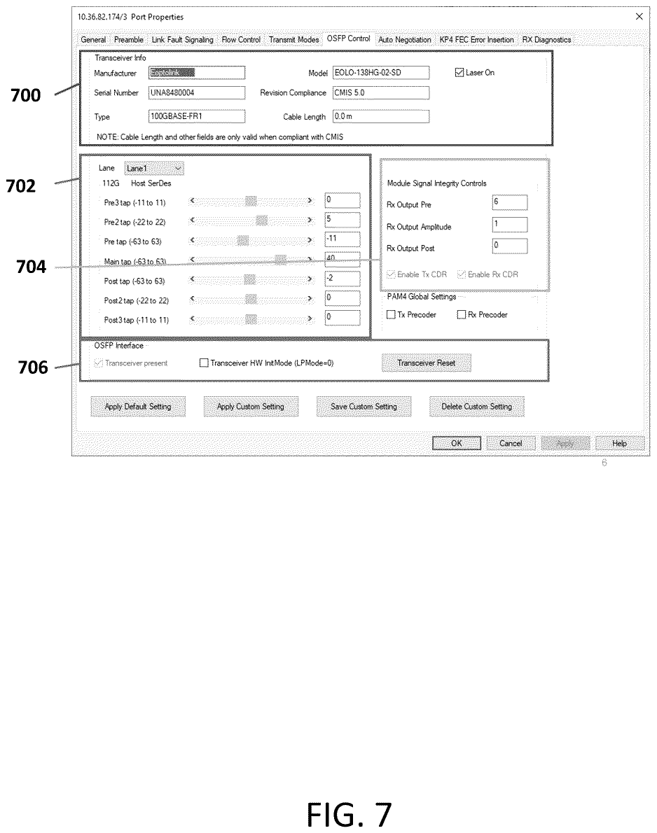

Another data component of these records comprises test port setting and configuration information (e.g., Tx or Rx test port setting and configuration parameter values, etc.) that is associated with a test port that is physically connected/coupled to the interconnect DUT. In some examples, this test port setting and configuration information is automatically obtained from the associated test ports or test port controller(s). In other examples, a test system user can manually input this test port setting and configuration information. Exemplary test port data could be incorporated into an interconnect library database record is shown in FIG. 7. In FIG. 7, the port configuration data includes transceiver information presented in a transceiver information area 700. A lane control area 702 is provided to store tap settings, which define transmit bias voltages applied to taps. The tap settings are used when testing an interconnect device under test. Storing the tap settings for a test in an interconnect library database record enables tests results conducted at different times to be more accurately compared. A module receive output equalization area 704 stores data for configuring electrical lane equalization values from the interconnect device under test to the interconnect device test system. An OSFP interface area 706 allows the user to define module hardware pin control settings and custom settings.

It is important to state that a record in interconnect library database 404 can be used for the creation of a test. Once a record created and stored in interconnect library database 404, that record or those records, can be pulled in and used to create a complete executable test. Additionally, in the case where interconnect device test system 100 has prescribed a test case test, a canned test, a record or records from the library can be pulled in and used to participate in the canned test. In preparation for and/or during execution of a test, an interconnect library database record associated with an interconnect DUT may be:
Created;
Edited (e.g., data in the record may be updated with new values obtained from the DUT, data in the record may be updated with new values associated with a test port involved in the test, etc.);
Accessed and information obtained from the record may be used to update data on the DUT (e.g., update one or more of the DUT's CMIS parameter settings, etc.); or
Exported from the test system (e.g., via an export file, such as a csv formatted file, or other data file formats.) for various uses including, but not limited to, training an artificial intelligence/machine learning (AI/ML) model.

Once a test case is executed and results/performance metrics are generated by interconnect device test system 100, some or all of the generated results/performance metrics may be logged and correlated with the associated interconnect library database record.

Returning to FIG. 4, in one example, interconnect device test system includes an AI/ML training data exporter module 422 that facilitates the collection of this correlated result +interconnect library database record and exports this correlated data for use in training AI/ML models (e.g., AI/ML models designed to predict the performance of distributed computing environments, AI/ML models intended to assist a test system operator in configuring a test/constructing a test case, etc.). Such AI/ML training data could be exported as an extensible markup language (XML) file, a comma separated value (CSV) file, or other data formats/structures.

In yet another example, interconnect device test system 100 includes a CMIS comparator engine 424 that operates to compare data stored in different records in interconnect library database. Using CMIS comparator engine 424, a test system user can select and designate an interconnect library database record for one DUT as a reference record. The test system user can then connect another physical DUT (of the same type), read that DUT's CMIS data and compare this DUT's CMIS record data to corresponding data in the reference record. CMIS comparator engine 424 may generate a comparison report and present the comparison report to a test engineer. Such capability is useful, for example, in scenario where a user has a group of DUT devices (e.g., optical transceiver modules, etc.) that should all be identical with respect to a subset of their CMIS data.

One of the DUTs is connected to the test system and an interconnect library database record (Record_1) is created for the DUT. The user designates Record_1 as the refence record. The user then connects another member of the DUT group to the test system and its CMIS data is read and compared to the CMIS data in the reference record. The user may specify which CMIS data is to be used in the comparison.

A test manager module 426 accesses the interconnect library record for a device currently plugged into one of test ports, uses the interconnect library record to generate and execute a test for testing the interconnect device under test, and storing, in the interconnect library database record, results of the test. Test manager module 426 as well as the remaining modules illustrated in FIG. 4 may be implemented using computer executable instructions stored in memory 402 and executed by processor 400.

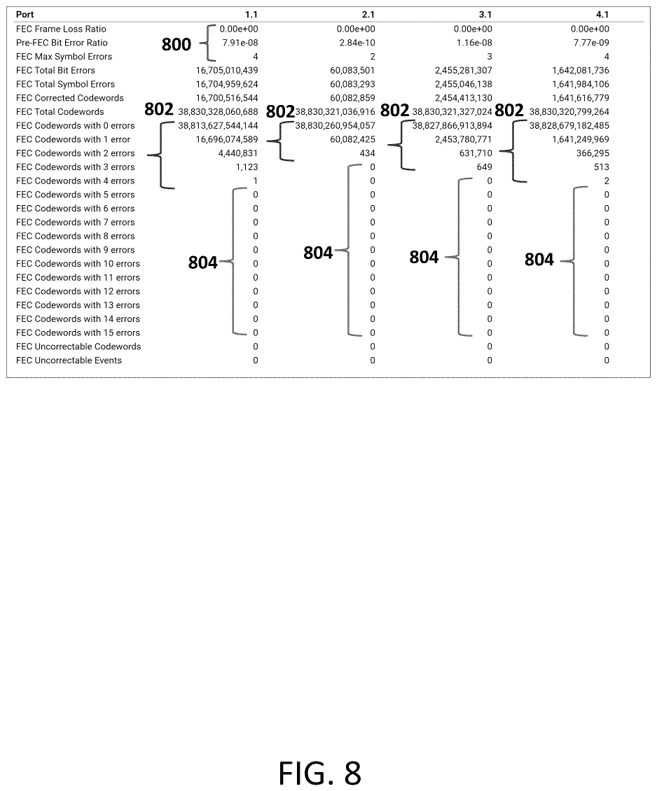

FIG. 8 is a diagram illustrating exemplary interconnect test result data that may be stored in interconnect library database 404. Referring to FIG. 8, the example interconnect test result data includes FEC performance statistics, such as frame loss ratio, FEC BER, and maximum symbol errors 800, FEC overhead measurements 802, and FEC margin data 804. Any of this data may be created by interconnect test device 100 when testing an interconnect device under test and stored in a record in interconnect library database 404 for the interconnect device under test along with CMIS and other data for the interconnect device under test.

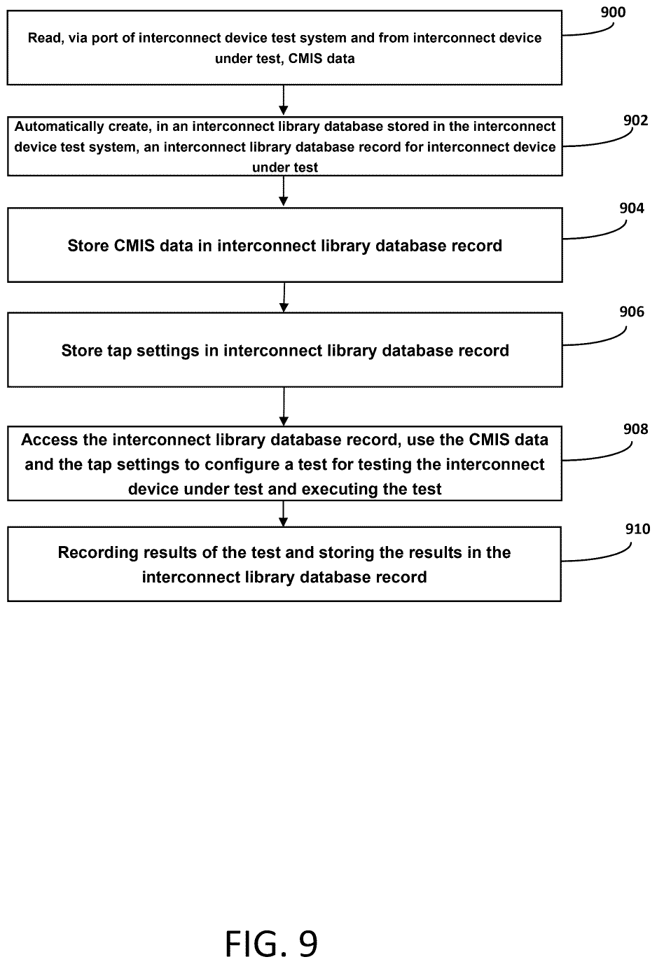

FIG. 9 is a flow chart illustrating an exemplary process for testing an interconnect device under test using an interconnect device test system with interconnect library database functionality. Referring to FIG. 9, in step 900, the process includes reading CMIS data via a port of an interconnect device test system from an interconnect device under test. For example, interconnect device test system 100 may read the CMIS data from the EEPROM of an optical or electrical transceiver connected to at least one port of interconnect device test system 100.

In step 902, the process includes automatically creating interconnect library database record for interconnect device under test. For example, interconnect device test system 100 may read the device serial number from the CMIS data and check whether a record is present in the interconnect device library database corresponding to the interconnect device under test. If a record is not present, interconnect device test system may create a new record in interconnect library database 404 for the interconnect device under test.

In step 904, the process includes storing the CMIS data in interconnect library database record. For example, interconnect device test system 100 may store the complete set of CMIS data read from the interconnect device under test in the interconnect library database record created for the interconnect device under test.

In step 906, the process includes storing tap settings in interconnect database record. For example, interconnect device test system 100 may store tap settings, such as those illustrated in FIG. 8, in the interconnect library database record for the interconnect device under test. Storing the tap settings is beneficial, especially when different tap settings are used for different iterations of a test of an interconnect device under test so that the test engineer can evaluate device performance and know the tap settings that led to any differences in performance.

In step 908, the process includes accessing the interconnect library database record, using the CMIS data and the tap settings to configure a test for testing the interconnect device under test, and executing the test. For example, interconnect device test system 100 may use the interconnect device serial number to look up a record in the interconnect library database for the interconnect device under test and use the tap settings and CMIS data in the record to configure the device under test for a test. Interconnect device test system 100 may then execute the test by transmitting signals to the interconnect device under test and recording signals transmitted by the interconnect device under test. The signals may include Ethernet frames transmitted to the device under test at line rates (e.g., 400 G, 800 G, etc.) specified in the interconnect library database records. Interconnect device test system 100 may calculate, as part of the test, measurements of bit error rate, numbers of FEC codewords having specified numbers of bit errors, etc.

In step 910, the process includes recording results of the test and storing the results in the interconnect library database record. For example, interconnect device test system 100 may record store test results, such as any of the FEC statistics illustrated in FIG. 9, in the interconnect library database.

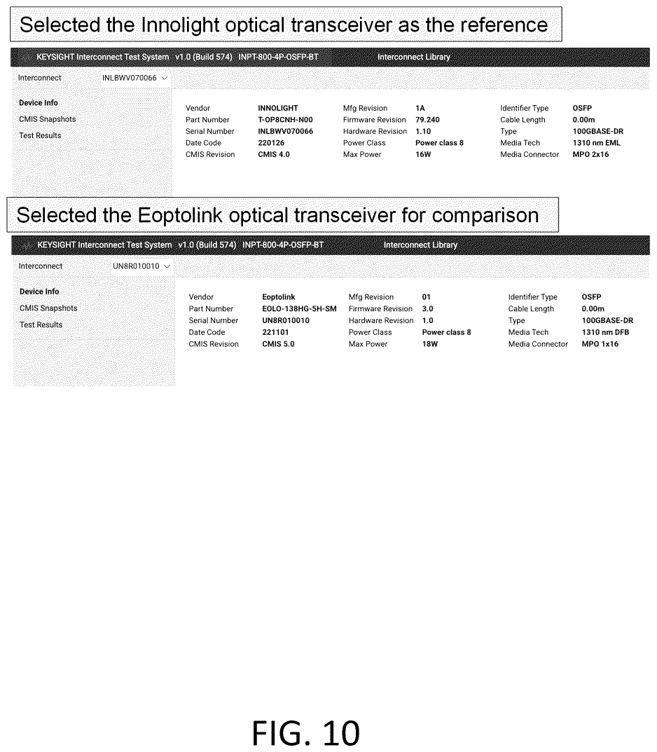

As described above, CMIS comparator engine 424 enables a user to compare the CMIS data for different interconnect devices. One example of when this functionality might be useful is in comparing interconnect devices from different manufacturers. The CMIS compare functionality provided by interconnect test system 100 will now be described in more detail with respect to FIGS. 10-14.

FIG. 10 illustrates computer screen shots of CMIS data stored in the interconnect library database for two different optical transceivers, one from Innolight and one from Eoptolink. As will be described below, the Innolight transceiver is selected as the reference transceiver, and the Eoptolink transceiver is selected as the transceiver to be compared to the Innolight transceiver.

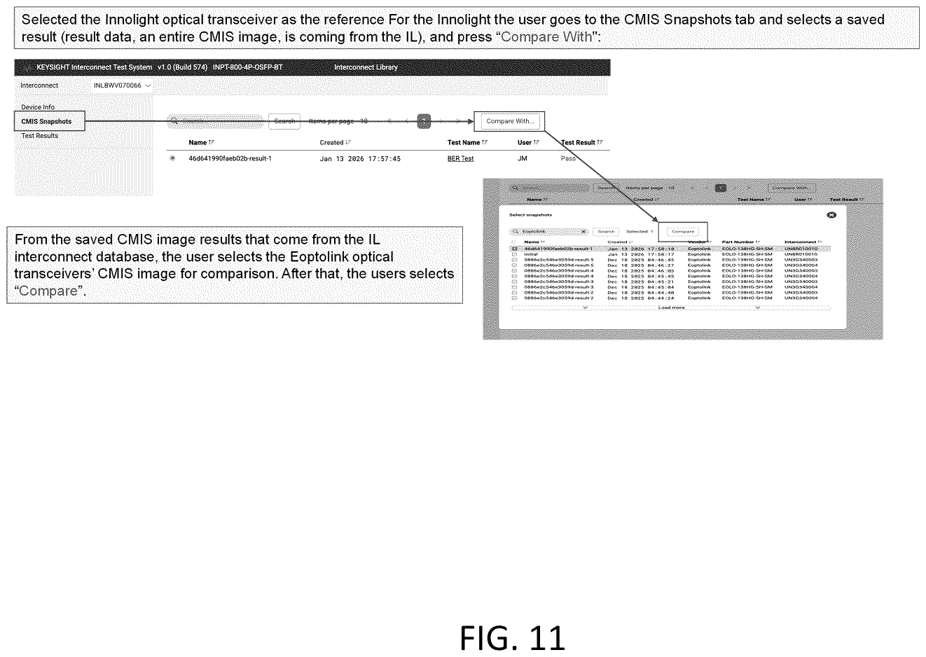

FIG. 11 illustrates computer screen shot of functionality provided by interconnect test system 100 for comparing CMIS data for the Innolight and Eoptolink transceivers. In FIG. 11, from the display of the CMIS data for the reference Innolight transceiver, the user accesses the CMIS Snapshots tab and selects a saved result from the interconnect library database (result data, an entire CMIS image) (in this case, the record for the Eoptolink transceiver) and clicks on a “Compare” button.

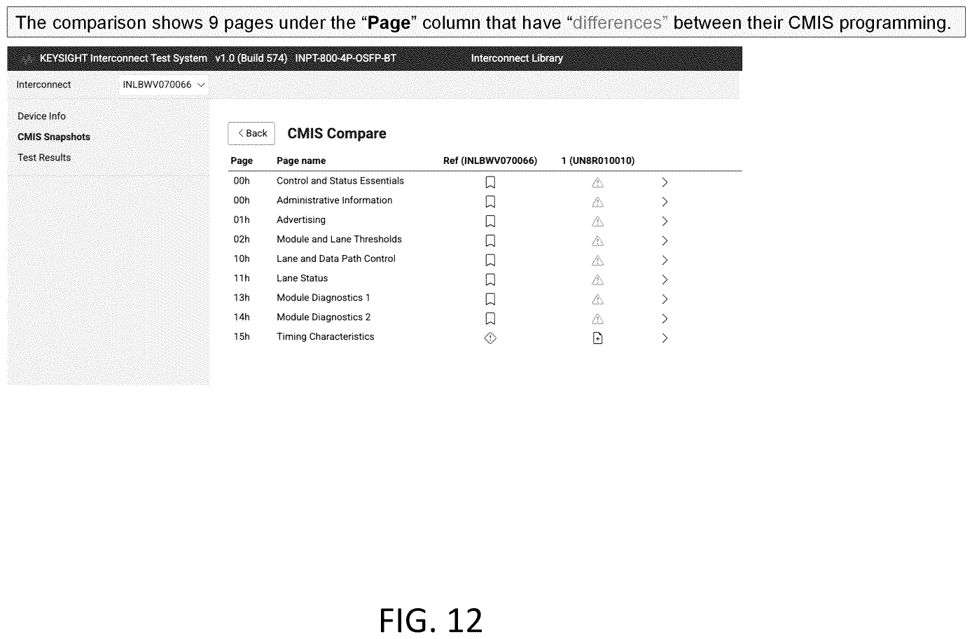

Once the user selects the database record for the reference transceiver, the database record for the transceiver to be compared to the data for reference transceiver, and accesses the “Compare” button, interconnect test system 100 executes a field by field comparison of the data from the two interconnect library database records. FIG. 12 is a computer screen shot illustrating a summary of results of such a comparison. In the illustrated example, the left-hand column represents memory pages of CMIS data from the Innolight transceiver, and the right-hand column represents memory pages of CMIS data from the Eoptolink transceiver. The display in FIG. 9 indicates that there are 9 pages of CMIS data where the CMIS programming of the Eoptolink transceiver differs from that of the Innolight transceiver.

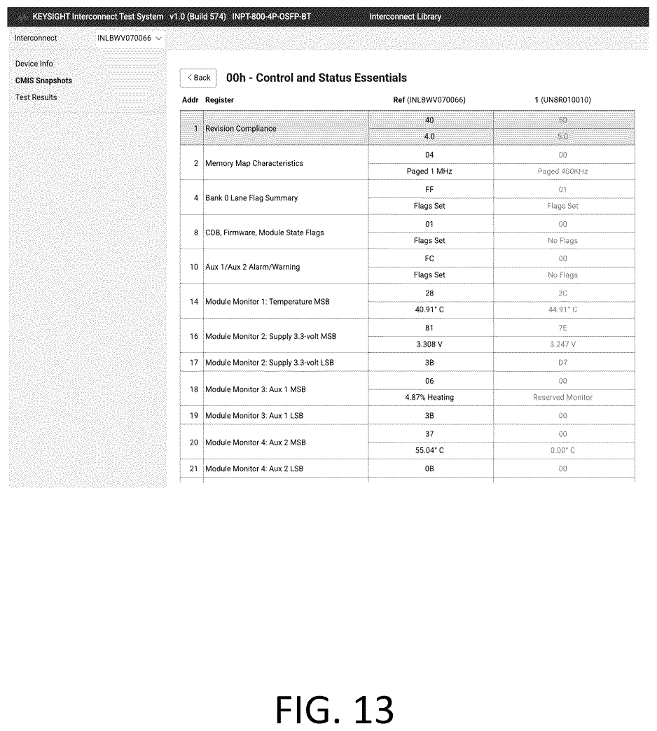

From the display in FIG. 12, interconnect device test system 100 provides the user with the functionality to drill down to investigate the identified differences in CMIS programming. FIG. 13 is a computer screen shot illustrating the result of the user selecting memory page “00h” to view the differences in CMIS programming on this page. In FIG. 13, the CMIS data obtained from the registers of the two CMIS devices is displayed with human readable labels that identify the type of data in each register. For example, for address location 1 on page 00h, interconnect device test system 100 displays the label “Revision Compliance”, which identifies the revision of the CMIS standard with which each interconnect device is compatible and displays the revision numbers for each interconnect device. Interconnect test system can output the comparison results illustrated in FIG. 13 in any suitable format, including Microsoft Excel or PDF format.

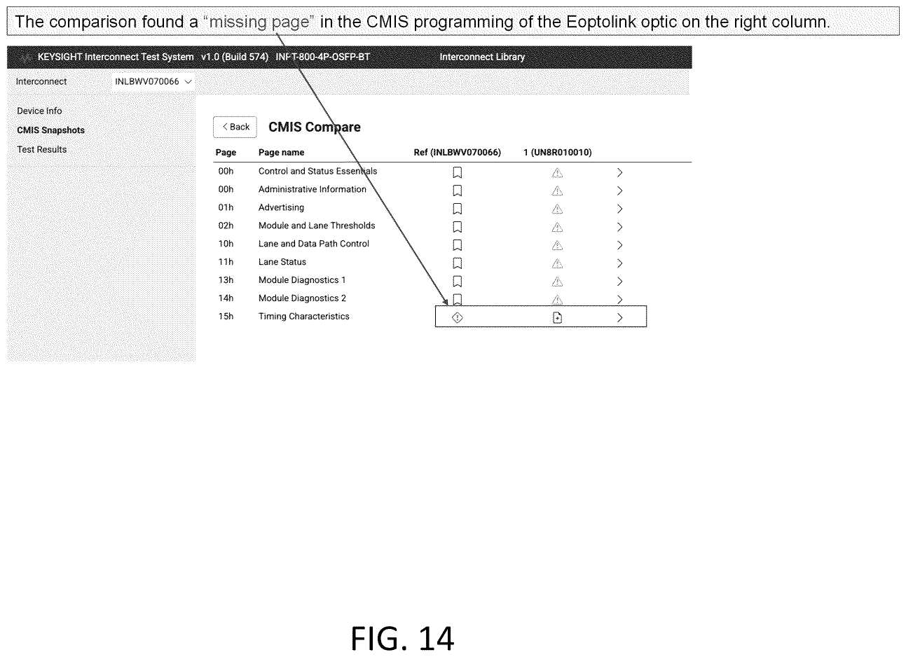

Another feature provided by interconnect device test system 100 is the ability to identify missing data from the reference transceiver or the whose CMIS data is being compared to the reference transceiver. FIG. 14 is a computer screen shot illustrating a graphical indication displayed by interconnect test system 100 when the reference Innolight transceiver is missing a timing characteristics page that is present in the Eoptolink transceiver.

Thus, the CMIS compare functionality provided by interconnect device system 100 provides a searchable, easy to use interface for the user to compare CMIS data for interconnect devices. CMIS data is displayed with human readable labels so that the user can easily determine the type of data that is present and being compared. The ability to identify missing CMIS data is another useful feature provided by interconnect device test system 100. In addition to the CMIS compare function illustrated by FIGS. 10-14, interconnect test system 100 may also provide module compare functionality that enables comparison of module data, such as tap settings, for different interconnect devices to be compared in the same manner as the CMIS data, including the human readable labels, drill down functionality and the ability to identify missing data. CMIS test system 100 may also provide a results compare function that enables test results for different interconnect devices stored in the interconnect library database to be compared in the same manner as the CMIS data, including the human readable labels, drill down functionality and the ability to identify missing data. Any of the aforementioned compare functionalities may be provided by comparator engine 424 illustrated in FIG. 4.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for testing electrical and optical interconnect devices, the system comprising:
a housing including at least one test port for physically connecting to an electrical or optical interconnect device under test;
at least one processor and a memory located within the housing;
an interconnect library database stored in the memory;
a common management interface specification (CMIS) system module executed by the at least one processor for reading, via the test port, CMIS data from the interconnect device under test, automatically creating an interconnect library database record in the interconnect library database for the interconnect device under test, storing the CMIS data in the interconnect library database record, and storing tap settings for the interconnect device under test in the interconnect library database record;
a test manager executed by the at least one processor for accessing the interconnect library database record, using the interconnect library database record, executing a test for testing the interconnect device under test, and storing, in the interconnect library database record, results of the test; and
a comparator engine for comparing at least the CMIS data of the interconnect device under test with CMIS data of another interconnect device stored in a user-selected interconnect library database record and reporting results of the comparing.

2. The system of claim 1 wherein the comparator engine is configured for providing a drill down function that allows a user to drill down to view details of differences between CMIS data of the interconnect device under test and the interconnect device identified in the user-selected interconnect library database record.

3. The system of claim 1 wherein the comparator engine is configured to identify pages of CMIS data that are missing from the CMIS data of the interconnect device identified in the user-selected interconnect library database record.

4. The system of claim 1 wherein the comparator engine is configured to display human-readable labels for the CMIS data of the interconnect device under test and the CMIS data of the interconnect device identified in the user-selected interconnect library database record.

5. The system of claim 1 wherein the comparator engine is configured for comparing the tap settings of the interconnect device under test with tap settings stored in the user-selected interconnect library database record and reporting results of the comparing.

6. The system of claim 1 wherein the comparator engine is configured for comparing the results of the test of the interconnect device under test with test results stored in the user-selected interconnect library database record and reporting results of the comparing.

7. The system of claim 1 comprising an artificial intelligence/machine learning (AI/ML) training data exporter module for extracting data from the interconnect library database and exporting the data as AI/ML model training data.

8. The system of claim 1 wherein the CMIS system module is configured to store the tap settings for a plurality of iterations of testing of the interconnect device under test in the interconnect library database record.

9. The system of claim 1 wherein the test manager is configured to record, as the results of the test, a bit error metric and a forward error correction metric of the interconnect device under test.

10. The system of claim 1 wherein the interconnect device under test comprises an electrical or optical transceiver.

11. A method for testing electrical and optical interconnect devices, the method comprising:
reading, via a port of an interconnect device test system and from an interconnect device under test, common management interface specification (CMIS) data;
automatically creating an interconnect library database record in an interconnect library database stored in the interconnect device test system;
storing the CMIS data in the interconnect library database record;
storing tap settings in the interconnect library database record;
using the CMIS data and the tap settings to configure a test for testing the interconnect device under test;
recording results of the test and storing the results of the test in the interconnect library database record; and
comparing at least the CMIS data of the interconnect device under test with CMIS data of another interconnect device stored in a user-selected interconnect library database record and reporting results of the comparing.

12. The method of claim 11 comprising providing a drill down function that allows a user to drill down to view details of differences between CMIS data of the interconnect device under test and the interconnect device identified in the user-selected interconnect library database record.

13. The method of claim 11 comprising automatically identifying pages of CMIS data that are missing from the CMIS data of the interconnect device identified in the user-selected interconnect library database record.

14. The method of claim 11 comprising displaying human-readable labels for the CMIS data of the interconnect device under test and the CMIS data of the interconnect device identified in the user-selected interconnect library database record.

15. The method of claim 11 comprising comparing the tap settings and results of the test of the interconnect device under test with tap settings and test results data stored in the user-selected interconnect library database record and reporting results of the comparing.

16. The method of claim 11 comprising extracting data from the interconnect library database and exporting the data as artificial intelligence/machine learning (AI/ML) model training data.

17. The method of claim 11 comprising storing the tap settings for a plurality of iterations of testing of the interconnect device under test in the interconnect library database record.

18. The method of claim 11 comprising recording, as the results of the test, a bit error metric and a forward error correction metric of the interconnect device under test.

19. The method of claim 11 wherein the interconnect device under test comprises and optical or electrical transceiver.

20. A non-transitory computer readable medium having stored thereon computer-executable instructions that when executed by a processor of a computer control the computer to perform steps comprising:
reading, via a port of an interconnect device test system and from an interconnect device under test, common management interface specification (CMIS) data;
automatically creating an interconnect library database record in an interconnect library database stored in the interconnect device test system;
storing the CMIS data in the interconnect library database record;
storing tap settings in the interconnect library database record; using the CMIS data and the tap settings to configure a test for testing the interconnect device under test;
recording results of the test and storing the results of the test in the interconnect library database record; and
comparing at least the CMIS data of the interconnect device under test with CMIS data of another interconnect device stored in a user-selected interconnect library database record and reporting results of the comparing.
